(19) United States
(12) Patent Application Publication
(10) Pub. No.: US 2004/0126649 A1
(43) Pub. Date: Jul. 1, 2004

(54) Simple procedure for growing highly-ordered nanofibers by self-catalytic growth

(76) Inventors: Jin-Ming Chen, Hsinchu (TW); Chien-Te Hsieh, Hsinchu (TW); Yue-Hao Huang, Hsinchu (TW); Hung-Hsiao Lin, Hsinchu (TW); Han-Chang Shih, Hsinchu (TW)

Correspondence Address: BIRCH STEWART KOLASCH & BIRCH, PO BOX 747, FALLS CHURCH, VA, 22040-0747, US

(21) Appl. No.: 10/402,996

(22) Filed: Apr. 1, 2003

(30) Foreign Application Priority Data
Dec. 30, 2002 (TW) 091137904

(51) Int. Cl. H01M 10/34; C25D 15/00

(52) U.S. Cl. 429/58; 205/109

(57) ABSTRACT

A low-cost, simple method for manufacturing highly-ordered nanofibers is provided. The feature of the procedure is using a self-catalytic mechanism. First of all, a porous membrane template is used as a filter to spread metal nanoparticles, which have a self-catalytic characteristic, onto a current collector. After removing, the membrane template, the nanoparticles grow and become highly-ordered nanofibers by heat treatment in an oxygen atmosphere. The nanofibers show superior field emission effects and are therefore ideal field emission sources.

### BACKGROUND OF THE INVENTION

1. Field of invention

The invention relates to a method for manufacturing nanofibers that can be used as field emission sources and, more particularly, to a simple method for manufacturing nanofibers of metal oxides.

2. Related Art

The characteristics and applications of many nano-scale materials have been widely studied in recent years. However, it is still a challenging problem to use a simple and low-cost manufacturing process to obtain homogeneous nanostructures. The question of the most interest is how to prepare highly ordered or super lattice structured nanometer materials with physical and chemical properties dramatically different from those of the bulk materials. Recent studies have shown that one can use the chemical vapor deposition (CVD), physical vapor deposition (PVD), electrodeposition and sol-gel methods to prepare nanofibers and nanowires of metals and oxides with specific properties. These quasi-one-dimensional nanostructured materials demonstrate unique properties for application in different fields. For example, using the ZnO nanofibers as the anode of a lithium battery can effectively increase the battery capacity density, elongate its lifetime, and provide a higher C-rate. The boron-doped SiO₂ nanowire has a high sensitivity. Such properties can be used to make sensors for chemical and biological purposes.

However, there is still a big distance between the laboratory experiments and mass productions. Taking the field emission displays as an example, although scientists have developed a new micro field emission device manufacturing technique that uses nanocarbon tubes. However, the process is still fairly complicated. First, the layer structure of the silicon substrate, metal, SiO₂, and polysilicon has micro holes of 2 μm in diameter using photolithography, photo resist and etching. The surface and the micro holes are deposited with TiN and Ni. Afterwards, the photo resist on the surface is washed away, leaving catalyst inside the center of the micro hole. Finally, the plasma-enhanced chemical vapor deposition (PECVD) method, and gases such as acetylene and ammonia at the temperature of 700° C. are employed to grow nanocarbon tubes in the micro holes. The growth range has a diameter of about 1 μm. After the growth, each micro hole has about tens of nanocarbon tubes, each having a diameter of about 10 nm˜50 nm and a length of about 0.4 μm.

In summary, the existing semiconductor manufacturing processes such as the photolithography and etching are complicated. Furthermore, the CVD and/or PVD coating machines cost too much. The area and density of the laboratory-grade nanofibers are also limited. Therefore, it is difficult for mass productions.

### SUMMARY OF THE INVENTION

The technical problems that the invention intends to solve are that the existing nanofiber manufacturing process is too complicated, that the product area and density are too small, and that the equipment cost is too high.

In view of the foregoing, the disclosed manufacturing method for producing highly-ordered nanofibers first deposits metal nanoparticles through nanometer holes of a template on an electrode covered by the template. Afterwards, the template is removed to expose the metal nanoparticles on the electrode. Finally, the nanoparticles are oxidized to form metal oxide nanofibers.

The invention achieves the following effects:

(1) The manufacturing process is simple and easy to be commercialized. It does not require semiconductor processes such as photolithography and etching in order to grow ordered metal oxide nanofibers on an electrode.

(2) It can grow large-area and high-density nanofibers, thereby reducing the number of production times and the cost.

(3) It does not require expensive CVD and/or PVD coating machines in order to grow one-dimensional nanometer structured materials. The cost can thus be greatly reduced.

### BRIEF DESCRIPTION OF THE DRAWINGS

The invention will become more fully understood from the detailed description given hereinbelow illustrational only, and thus are not limitative of the present invention, and wherein:

FIGS. 1 to 3 are schematic views of the disclosed manufacturing method for manufacturing highly-order nanofibers:

FIG. 4 shows the scanning electronic microscopic images, wherein FIGS. 4(a) and 4(b) show copper crystal nuclei with particle diameters of 50 nm and 100 nm, and FIGS. 4(c) and 4(d) show copper oxide nanofibers with diameters of 50 nm and 100 nm;

FIGS. 5(a)-5(b) show the peaks of an X-ray diffraction pattern, wherein FIG. 5(a) shows the result of using a copper foil as the electrode material for growing Cu (111) crystals, and FIG. 5(b) shows the obtained highly-pure and highly-crystallized copper oxide:

FIGS. 6(a)-6(c) show images obtained from a penetrative electronic microscope and a high-resolution penetrative electronic microscope, wherein: FIG. 6(a) shows that the copper oxide nanofiber obtained in the experiment has a solid structure, and FIG. 6(b) shows the arrangement of the copper oxide nanofiber atomic layer and FIG. 6(c) is an inverse lattice diagram of the copper oxide after selection area diffraction (SAD); and

FIG. 7(a) and 7 (b) shows the J-E curve and F-N plot of the field emission effect when using the oxide nanofibers.

### DETAILED DESCRIPTION OF THE INVENTION

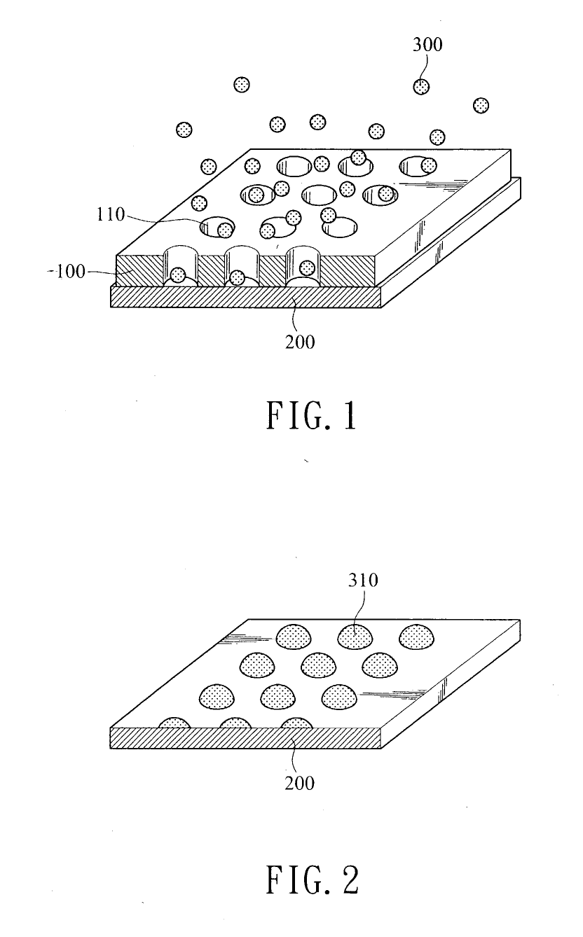

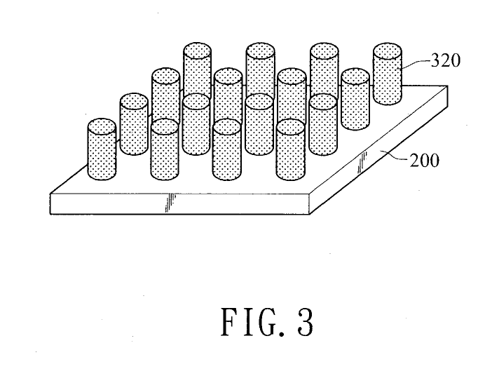

With reference to FIGS. 1 to 3, the disclosed manufacturing method for producing highly-ordered nanofibers is explained using the embodiment of a copper oxide nanofiber growing mechanism.

The main reason for choosing copper is that the transition metals are self-catalytic. Copper oxides formed during the oxidization process grow toward a preferred direction to lower its activation energy. It is thus ideal for growing highly-ordered nanofibers. Copper oxides further have the usual semiconductor properties. Its band gap is only 0.14 eV, far less than the theoretical range that the band gap of a semiconductor material has to be less than 3 eV. Therefore, copper oxides are evaluated to be a field emission electron source material.

(1) First, a template plate 100 with holes 110 is attached to the surface of an electrode 200. A high DC voltage is then imposed in a specific electrolyte environment to perform the electrodeposition step. After nucleation, copper ions 300 form copper atom crystal nuclei (or copper nanoparticles) homogeneously in the holes 110 on the surface of the electrode 200. The template plate 100 is a porous thin film of a material selected from natural templates such as pine tree rings and wood, artificial templates such as anodic alumina oxide (AAO) and MCM-41 mesoporous molecular sieve, and polymers such as polycarbonate (PC) and polyester (PE). The electrode 200 is a current collector of a material selected from copper foils, nickel foils, and stainless steel foils. The surface of the electrode is washed by alkalis and acids before use, which is helpful for copper ions to deposit. Moreover, the spin-coating, metal oxide chemical vapor deposition (MOCVD), physical vapor deposition (PVD), electroless deposition, sol-gel, and chemical impregnation combined with heat treatment can also be employed to complete the current step.

(2) Afterwards, the template plate 100 is removed using wet etching, plasma etching or heat treatment (performed at specific temperature, time and atmosphere in a furnace). This step exposes the copper crystal nuclei 310 on the electrode 200.

(3) The electrode 200 is put inside a furnace to perform gas-solid reactions. The furnace is supplied with oxygen and the oxidization process is performed at a temperature lower than the copper's melting point. Due to the self-catalytic mechanism of copper, it is growing in a preferred direction to lower the activation energy. Therefore, highly-ordered copper oxide nanofibers 320 are obtained.

The above-mentioned process is not only featured in its simplicity and that it does not need expensive CVD and/or PVD coating machines, it can be used to grow large-area and high-density nanofibers. Therefore, the invention can achieve the goals of reducing, the number of production times and the cost.

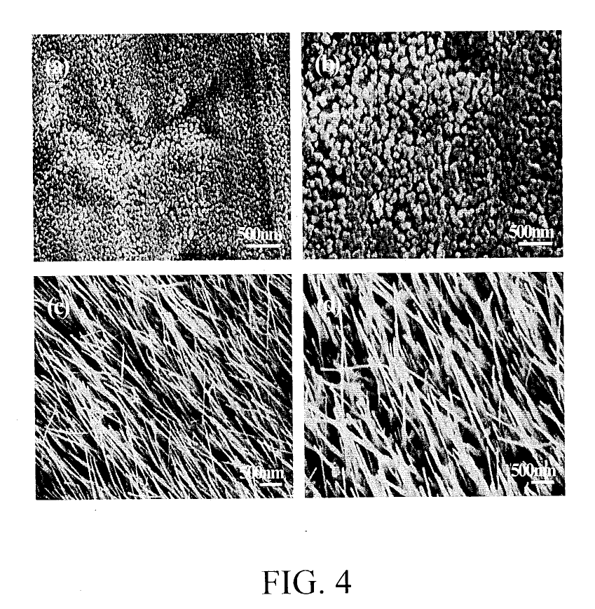

The scanning electronic microscopic images in FIG. 4(a)-4(b) shows copper crystal nuclei of different diameters formed in holes of different sizes on the template plate and copper oxide fibers of different diameters. FIGS. 4(a) and 4(b) are copper crystal nuclei with particle diameters of 50 nm and 100 nm. FIGS. 4(c) and 4(d) are copper oxide nanofibers with diameters of 50 nm and 100 nm. The density of the nanofibers is between 10⁷/cm² and 10⁸/cm². Moreover, from FIGS. 4(c) and 4(d), we see that ordered and highly dense copper oxide nanofibers are obtained.

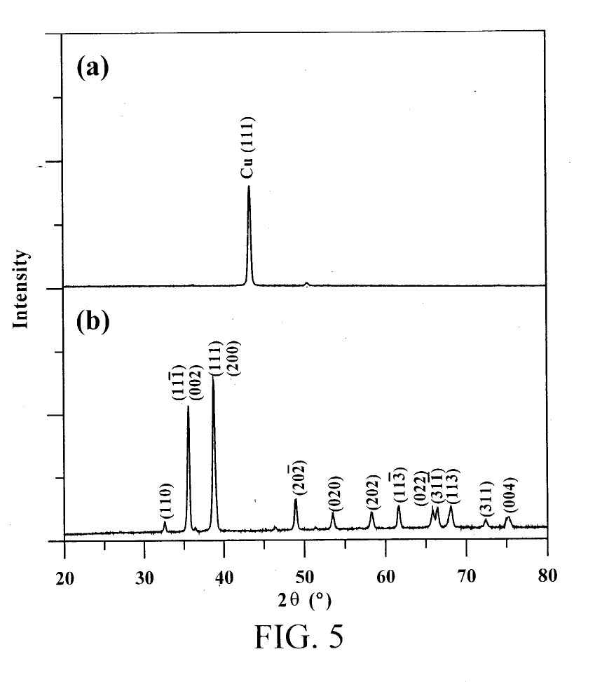

FIG. 5(a) and 5(b) show the peaks of an X-ray diffraction pattern. FIG. 5(a) is the result of using a copper foil as the electrode material for growing Cu (111) crystals. FIG. 5(b) shows the obtained highly pure and highly crystallized copper oxide.

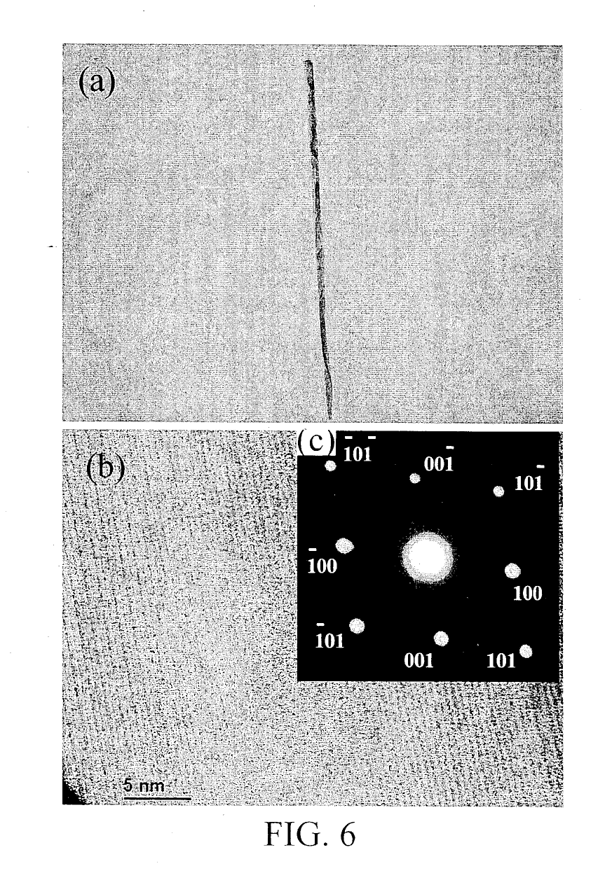

FIG. 6(a)-6(c) contain images obtained using a penetrative electronic microscope and a high-resolution penetrative electronic microscope. FIG. 6(a) shows that the copper oxide nanofiber obtained in the experiment has a solid structure. FIG. 6(b) shows the arrangement of the copper oxide nanofiber atomic layer. FIG. 6(c) is an inverse lattice diagram of the copper oxide after selection area diffraction (SAD). It is seen from this that the copper oxide nanofibers are highly crystalline.

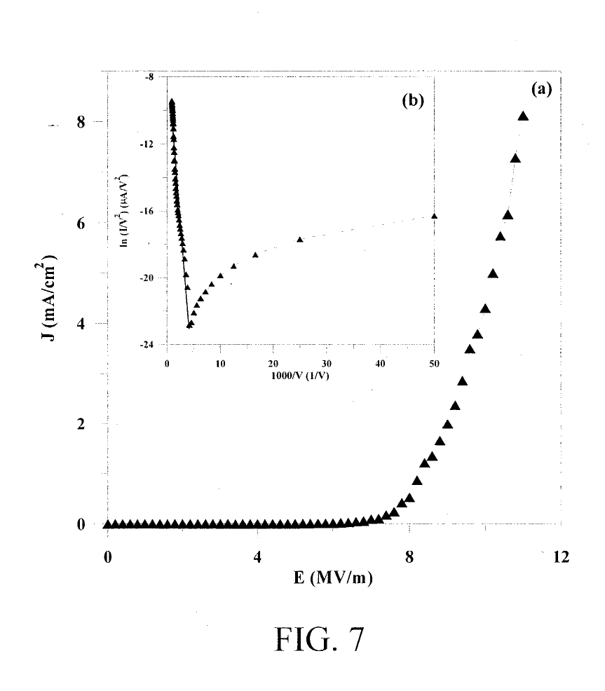

FIG. 7(a) and 7(b) show the characteristic curves of the field emission effect when using the oxide nanofibers. First, we plot the current density J versus the input electric field E to obtain a J-E curve. Using the Fowler-Nordheim equation, the J-E curve is converted into the so-called F-N plot (i.e. 1n(I/V²) versus 1/V or 1n(J/E²) versus 1/E). The Fowler-Nordheim equation is:

I/V²=a exp(−bΨ^{3/2}/βV), (A)

where Ψ is the work function in units of eV,β is the geometric gain factor, and a and b are specific constants. When converted into the F-N plot, the expression becomes as follows:

1n(J/E²)=1n a−BΨ^{3/2}/E, (B)

where J is the current density in units of mA/cm², E is the imposed electric field strength in units of V/μm, and B is a specific constant reported to be 6.87×10⁷. The J-E curve and F-N plot obtained from the experiment are shown in FIG. 7(a) and 7(b). From the drawings, we obtain that the starting voltage of the copper oxide nanofibers is about 6-7 V/μm. The work function has a value between 0.75 eV and 3.48 eV, which is slightly below the work function value for graphite in the literatures. The distribution structure of the material is compatible with the requirement that a field emission planar display have a high bright spot density (10⁷−10⁸ spots/cm²). Moreover, after multiple cyclic tests, a certain field effect current can be maintained. Therefore, it is an ideal material for electronic field emission devices.

In addition to copper oxides, we also try other substitute materials. The experimental results indicate that the transition metals, including Fe, Co, Ni, and Zr, can form metal oxide nanofibers using the above-mentioned manufacturing process. Some non-transition elements can also form metal oxide nanofibers, such as ZnO and ITO.

Certain variations would be apparent to those skilled in the art, which variations are considered within the spirit and scope of the claimed invention.

What is claimed is:

1. A method for manufacturing highly-ordered nanofibers comprising the steps of:
depositing a plurality of metal nanoparticles through a plurality of nanometer holes of a template onto an electrode covered by the template;
removing the template to expose the metal nanoparticles on the electrode; and
oxidizing the metal nanoparticles to form a plurality of metal oxide nanofibers.

2. The method of claim 1, wherein the method of depositing the metal nanoparticles is selected from the group consisting of electrodeposition, spin-coating, metal oxide chemical vapor deposition (MOCVD), physical vapor deposition (PVD), electroless deposition. sol-gel, and chemical impregnation combined with heat treatment.

3. The method of claim 1, wherein the method of removing the template is selected from the group consisting of wet etching, plasma etching and heat treatment.

4. The method of claim 1, wherein the metal nanoparticle is a transition metal.

5. The method of claim 1, wherein the metal nanoparticle is selected from the group consisting of Fe, Co, Ni, Zr, Zn, and In/Sn.

6. The method of claim 1, wherein the electrode is selected from the group consisting of copper foils, nickel foils, and stainless steel coils.

7. The method of claim 1, wherein the template is selected from a group consisting of pine tree rings, wood, anodic alumina oxide (AAO), MCM-41 mesoporous molecular sieve, polycarbonate (PC) and polyester (PE).

8. The method of claim 1, wherein the cross-sectional diameter of the metal oxide nanofiber is controlled by the inner diameter of the hole on the template.

9. The method of claim 1, wherein the method of oxidizing the metal nanoparticle is achieved by placing the electrode attached with the metal nanoparticles into a furnace, supplying oxygen and performing heat treatment at a temperature below the melting point of the metal nanoparticle.

10. The method of claim 1 wherein the metal oxide nanofiber is used as field emission sources.

11. A highly-ordered nanofiber made of a metal oxide, which is formed through a method comprising the steps of:
depositing a plurality of metal nanoparticles through a plurality of nanometer holes of a template onto an electrode covered by the template;
removing the template to expose the metal nanoparticles on the electrode; and
oxidizing the metal nanoparticles to form a plurality of highly-ordered metal oxide nanofibers.

12. The method of claim 11, wherein the method of depositing the metal nanoparticles is selected from the group consisting of electrodeposition, spin-coating, metal oxide chemical vapor deposition (MOCVD), physical vapor deposition (PVD), electroless deposition, sol-gel, and chemical impregnation combined with heat treatment.

13. The method of claim 11, wherein the method of removing the template is selected from the group consisting of wet etching, plasma etching and heat treatment.

14. The method of claim 11, wherein the metal nanoparticle is a transition metal.

15. The method of claim 1, wherein the metal nanoparticle is selected from the group consisting of Fe, Co, Ni, Zr, Zn, and In/Sn.

16. The method of claim 11, wherein the electrode is selected from the group consisting of copper foils, nickel foils, and stainless steel coils.

17. The method of claim 11, wherein the template is selected from a group consisting of pine tree rings, wood, anodic alumina oxide (AAO)-MCM-41 mesoporous molecular sieve, polycarbonate (PC) and polyester (PE).

18. The method of claim 1, wherein the cross-sectional diameter of the metal oxide nanofiber is controlled by the inner diameter of the hole on the template.

19. The method of claim 11, wherein the method of oxidizing the metal nanoparticle is achieved by placing the electrode attached with the metal nanoparticles into a furnace, supplying oxygen and performing heat treatment at a temperature below the melting point of the metal nanoparticle.

20. The method of claim 11, wherein the metal oxide nanofiber is used as field emission sources.
